(19) United States
(12) Patent Application Publication
(10) Pub. No.: US 2010/0291995 A1
(43) Pub. Date: Nov. 18, 2010

(54) METHODS AND APPARATUS FOR A PROMOTIONAL COUPONING SYSTEM

(75) Inventors: Elizabeth Vicens, Glendale, CA (US); Robert Denham, Reading (GB); Eric Meyerhofer, Pasadena, CA (US)

Correspondence Address: FITZPATRICK CELLA HARPER & SCINTO, 1290 Avenue of the Americas, NEW YORK, NY, 10104-3800, US

(73) Assignee: FUTURELOGIC, INC., Glendale, CA (US)

(21) Appl. No.: 12/669,787

(22) PCT Filed: Jul. 23, 2008
(86) PCT No.: PCT/US2008/070940

§ 371 Date: Jul. 2, 2010

Related U.S. Application Data
(60) Provisional application No. 60/951,318, filed on Jul. 23, 2007.

(51) Int. Cl. A63F 9/24; A63F 13/00

(52) U.S. Cl. 463/25; 463/30

(57) ABSTRACT

The present invention identifies a promotional coupon system (PCS) for use with cash-less slot machines and games to perform promotional couponing using patron recognition while maintaining patron anonymity, to perform promotional couponing on one or more segments of a gaming establishment floor, and to perform promotional couponing to direct patrons to a particular location or service in a gaming establishment such as a restaurant or show, among others.

### CROSS-REFERENCE TO RELATED APPLICATIONS

The present application claims the benefit of U.S. Provisional Application No. 60/951,318 filed Jul. 23, 2007 the contents of which are incorporated by reference as if stated in full herein.

### BACKGROUND OF THE INVENTION

1. Field of the Invention

This invention relates to promotional couponing and more specifically to anonymous tracking of a patron for promotional couponing in a gaming establishment.

2. Background

The gaming machine manufacturing industry provides a variety of gaming machines for the amusement of gambling players. An exemplary gaming machine is a slot machine. A slot machine is an electro-mechanical game wherein chance or the skill of a player determines the outcome of the game. Slot machines are usually found in casinos or other more informal gaming establishments.

The gaming machine manufacturers have provided cash-less enabled games to the market for more than five years, and there now exists a broad population of such games in the casino industry. Cash-less enabled games are so named due to the fact that they can conduct their player's financial exchange with a mixture of traditional paper and coin currency and vouchers redeemable for cash or game credits.

Two pieces of necessary equipment for a cash-less enabled game are a printer to produce the vouchers, and a bill acceptor that supports automatic reading of the vouchers. In a cash-less enabled gaming system, when a player cashes out, the game is signaled and depending on the size of the pay out, it can either present coins in the tradition method of a slot machine, or it can cause the printers which are installed in such machines to produce a voucher containing the value of the pay out. The voucher may then either be redeemed for cash at the cashier's cage for currency, or it may be inserted into one of the casino's games' bill acceptor, at which point the network and server to which the game is connected will recognize the voucher as valid, redeem it and place the appropriate amount of playing credits on the game.

For more than five years, cash-less enabled games have found an increasing acceptance and use in the gaming industry with both the players, who enjoy the speed of play and ease of transporting their winnings around the casino, and the casinos who have realized significant labor savings in the form of reduced coin hopper reloads in the games, and an increase in revenue due to speed of play. The broad installation base of cash-less enabled games guarantees a wide installed base of networked games and their installed printers which additionally may be used to print coupons and promotions for the captive player audiences.

In typical casino operations, the games are networked to a main server which monitors various metrics of activity on the games for regulatory, accounting and promotional activities related to frequent player club cards which participating patrons insert into the games when they play. The server related to promotions for player club cards is referred to as the Player Tracking Server. Games share real-time play metrics with the Player Tracking Server in order to support frequent player incentives.

This invention describes enhancements to current casino operations regarding promotional couponing and promotional activities.

### DEFINITIONS

For the purposes of this document the following definitions apply:

“Gaming Establishment”—A gaming entity such as a casino and/or associated properties.

“PCS”—acronym for Promotional Coupon System, the system which is responsible for promotional couponing and creating and managing promotional coupons.

“Gaming Machine”, “Game Machine”, “Game”—A slot machine, gaming machine, game table, or other game in a gaming establishment.

“PTS”—acronym for Player Tracking System, the system installed in a gaming establishment used to monitor game play activity by participating players. A Player Tracking System is a rudimentary part of the existing gaming establishment industry architecture.

“Cash-Out Voucher System”—The system installed in a gaming establishment used to create cash-out voucher records and issued data packets to Gaming Machines which will cause it to print a cash-out voucher. A Cash-out Voucher System is a rudimentary part of the existing gaming establishment industry architecture for casinos supporting cash-less gaming.

“POS”—acronym for Point-of-Sale, the system installed in a casino at various locations where business in the gaming establishment is transacted, such as a retail shop, restaurant, ticket sales counter, front desk, etc.

### FEATURES OF THE INVENTION

The present invention is a promotional coupon system (PCS) for use with games such as cash-less slot machines to perform promotional couponing using patron recognition while maintaining patron anonymity, to perform promotional couponing on one or more segments of a gaming establishment floor, and to perform promotional couponing to direct patrons to a particular location or service in a gaming establishment such as a restaurant or show, among others.

In one aspect of the invention, the PCS performs promotional couponing; the promotional couponing may include the creation, generation, issuance, and/or redemption of promotional coupons and/or other items of interest to one or more patrons of a gaming establishment.

In another aspect of the invention, the PCS may be coupled to a visual detection system or security system used in a gaming establishment, said system may comprise one or more cameras, among others to visually identify patrons when entering a gaming establishment or while anywhere within a gaming establishment, the visual identity may include an image or photograph which may be stored in a database of said system with or without a unique identifier, any or all the contents of said database may be shared with or transferred to the PCS.

In another aspect of the invention, the PCS may be coupled to a visual detection system or security system used in a gaming establishment, said system may perform signaling specifically to visually identify when major players or key players of games have entered a gaming establishment or while anywhere within a gaming establishment; the signaling notifying the PCS, the signaling notifying staff using communication and/or messaging devices such as radio, pagers, and telephony, among others.

In another aspect of the invention, the PCS may be coupled to a visual detection system or security system, the PCS receiving data from said system, the data not including personal patron identification information, such as the patron's name, and the PCS performing promotional couponing while maintaining patron anonymity.

In another aspect of the invention, the PCS may be coupled to a visual detection system or security system; the PCS receiving data from said system, the data may include patron identification such as patron name.

In another aspect of the invention, the PCS may update data related to anonymous patrons to include patron identification such as the name of the patron, among others thereby identifying the patron in the PCS and/or other coupled systems.

In another aspect of the invention, the PCS may store and track data related to a patron while maintaining patron anonymity by using a unique identifier not associated with any personal information of the patron.

In another aspect of the invention, the PCS may selectively download data and/or enable promotional activity in one or more segments of a gaming establishment.

In another aspect of the invention, the PCS may enable promotional activity aimed at steering patron traffic to a particular service or location of the gaming establishment.

In another aspect of the invention, the PCS may preload promotional couponing to one or more segments of a gaming establishment, the enabling of the promotional activity pending one or more authorizations and/or approvals.

In another aspect of the invention, the PCS may define, transmit, use, and respond to one or more triggers and/or trigger data by which one or more promotional coupons may be generated by a printer.

### BRIEF DESCRIPTION OF THE DRAWINGS

These and other features, aspects, and advantages of the present invention will become better understood with regard to the following description and accompanying drawings where:

FIG. 1 is a diagram of the PCS coupled to visual detection system and other systems in accordance with an exemplary embodiment of the present invention;

FIG. 2 is an illustration of the PCS coupled to other systems in a gaming establishment to perform promotional couponing in accordance with an exemplary embodiment of the present invention;

FIG. 3 is an illustration of a segmented gaming establishment floor in accordance with an exemplary embodiment of the present invention;

FIG. 4 is a flow chart of a patron recognition process in accordance with an exemplary embodiment of the present invention;

FIG. 5 is a flow chart of a promotions request and download process for a segmented gaming establishment floor in accordance with an exemplary embodiment of the present invention;

FIG. 6 is a flow chart of a promotions request and download process for steering patron traffic for a segmented gaming establishment floor in accordance with an exemplary embodiment of the present invention; and

FIG. 7 is a flow chart of a promotion create and preload process in accordance with an exemplary embodiment of the present invention.

FIG. 8 is a block diagram of a PCS 100 in accordance with an exemplary embodiment of the present invention.

### DETAILED DESCRIPTION

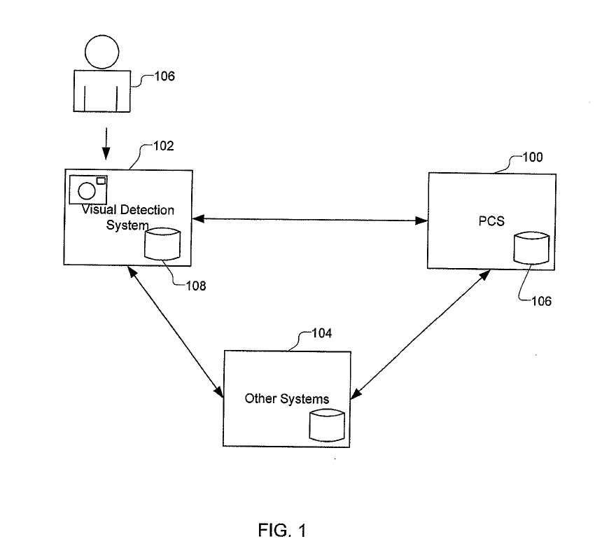

FIG. 1 is a diagram of a PCS 100 coupled to visual detection system 102 and other systems 104 in accordance with an exemplary embodiment of the present invention. Illustrated are the PCS 100, a visual detection system 102, and other systems. Any component may be optional.

The PCS 100 performs promotional couponing. The promotional couponing may include the creation, generation, issuance, and/or redemption of promotional coupons and/or other items of interest to one or more patrons of a gaming establishment. The PCS 100 may comprise one or more databases 106 for information related to anonymous patrons and identified patrons, as well as promotional activities, promotional coupon issuance and redemption, and triggers, among others. The PCS 100 may update data related to patron anonymity to include personal patron identification information such as the name of the patron, for example, if the patron elected to be identified. The PCS 100 may store and track data related to a patron while maintaining patron anonymity by using a unique identifier that may be associated with an image or photograph but not associated with any personal information of the patron.

Additionally, the PCS 100 may interface with the visual detection system 102 and/or other systems 104. The PCS 100 may define, transmit, use, and respond to one or more triggers and/or trigger data by which one or more promotional coupons may be generated by a printer. These triggers and/or trigger data may include any of the following, among others:

a) identifier received from visual detection system 102

b) match received from visual detection system 102

c) patron check-in

d) patron check-out

e) purchase made

d) amount wagered

e) amount lost

f) rate of play

g) length of play

h) issuance per trigger

i) birthday

j) frequency selector

k) issue period

l) duration of current session of play

For example, the PCS 100 may receive a trigger from the visual detection system 102 that an anonymous patron 106 has entered the gaming establishment. This trigger may signal the PCS 100 by transmitting a unique identifier to the PCS 100. The visual detection system 102 then may signal the PCS 100 that the same patron is playing a certain game. The PCS 100, in response to the trigger and signaling, may transmit promotional information to a game (not shown) or a coupled printer in the game to generate one or more promotional coupons and/or other materials of interest to the patron. In one variation, other systems 104 such as a communication system may signal the PCS 100 that the same patron 106 is playing a certain game. The PCS 100, in response to the trigger from the visual detection system 102 and signaling from the communication system, may transmit promotional information to the game and/or coupled printer in the game.

In another example, the PCS 100 may receive a first trigger from the visual detection system 102 that an anonymous patron 106 or valuable patron has entered the gaming establishment. The PCS 100 then may receive a second trigger from another system 104 such as a lodging management system that the patron 106 may be checking in. The PCS 100, in response to the first and second triggers, may transmit promotional information to the lodging management system to allow a coupled printer to generate one or more promotional coupons and/or other materials of interest to the patron. In one variation, the PCS 100, in response to the first trigger, may predetermine the types and/or number of promotional coupons and/or other materials of interest to issue to the patron. After the PCS 100 receives the second trigger, the PCS 100 may transmit the promotional information other systems 104.

In another example, the PCS 100 may receive a trigger from other systems 104 such as a point-of-sale system (POS) that a patron 106 has made a purchase. The PCS 100, in response to the purchase made trigger, may transmit promotional information to the POS to allow a coupled printer to generate one or more promotional coupons and/or other materials of interest to the patron 106.

The PCS 100 may be coupled to a visual detection system 102 to receive data. For example, the data may not include patron identification such as patron name but may include an image or photograph with an associated unique identifier or just a unique identifier. In this embodiment, the PCS 100 may perform promotional couponing while maintaining patron anonymity by using the unique identifier. Additionally, data such as an updated image or photograph may be transmitted to the PCS 100 from the visual detection system 102 using the same unique identifier to synchronize the unique identifier in the PCS 100 with the unique identifier in the visual detection system 102.

In another embodiment, data such as another identifier tied to a first unique identifier may be transmitted to the PCS 100 from the visual detection system 102. For example, a second image or photograph of the same patron is captured by the visual detection system 102. This image or photograph may comprise its own unique identifier which may be mapped to the unique identifier of a first image or photograph of the same patron thereby having multiple images or photographs of the same patron. The first unique identifier may be mapped to the unique identifier in the PCS 100 thereby allowing the PCS 100 to build or maintain a database for the patron.

The data in the PCS 100 may be stored in one or more databases. The data may comprise any or all of the following as defined in Table I as follows, among other types of data not illustrated:

TABLE I

| Data | Attribute(s) | Description |
|---|---|---|
| Anonymous Patron | IMG_ID | Unique Identifier associated with each |
| | | image or photograph. |
| | IMG_DATE | Date associated with each image or |
| | | photograph. |
| | IMG_FILE | The file containing the actual image or |
| | | photograph. |
| Patron | PATRON_ID | Unique identifier associated with |
| | | a patron. May be mapped to the |
| | | Anonymous Patron IMG_ID field should |
| | | a patron elect to be identified. |
| | PATRON_NAME | The name of the patron. |
| | PATRON_ADDRESS | The address of the patron. |
| | PATRON_TELEPHONE | The telephone number of the patron. |
| | PATRON_EMAIL | The email address of the patron. |
| Promotions Issued | PROMO_ID | Unique Identifier associated with each |
| | | promotion. |
| | PROMO_DATE_ISSUED | The date the promotion was issued to the |
| | | patron. |
| | PROMO_TYPE | The type of promotion issued to |
| | | the patron. |
| | PROMO_ISSUED_NUM | The total number of promotions issued to |
| | | the patron. |
| | PROMO_ISSUED_LOC | Information on the location where one or |
| | | more promotions were issued. |
| Promotions Redeemed | PROMO_ID | Mapped to the Promotions Issued |
| | | PROMO_ID field. |
| | PROMO_REDM_DATE | The date the promotion was redeemed. |
| | PROMO_REDM_NUM | The total number of promotions |
| | | redeemed by the patron. |
| | PROMO_REDM_LOC | Information on the location where one or |
| | | more promotions were redeemed. |

The visual detection system 102 may comprise one or more cameras, among others not shown which may be used to visually identify patrons when entering a gaming establishment or while anywhere within a gaming establishment. The visual identity may include an image or photograph which may be stored in a database 108 of the visual detection system 102 with or without a unique identifier.

The visual detection system 102 may interface with the PCS 100 and/or other systems 104 to share and/or transfer any or all the contents of the database. For example, data related to a matched image of a valuable patron may be shared and/or transferred to the PCS 100; thus the PCS 100 may build and/or maintain a history of the promotional activity of the valuable patron. The same data may be shared and/or transferred to other systems 104 such as a property or lodging management system where lodging accommodations may be pre-arranged or confirmed prior to the patron checking in at the front desk.

The visual detection system 102 may perform signaling specifically to visually identify when major players, key players of games, and/or other players and patrons have entered a gaming establishment or while anywhere within a gaming establishment. The signaling may be used to interface with and notify the PCS 100 and/or the gaming establishment staff using communication and/or messaging devices such as radio, pagers, and telephony, among others.

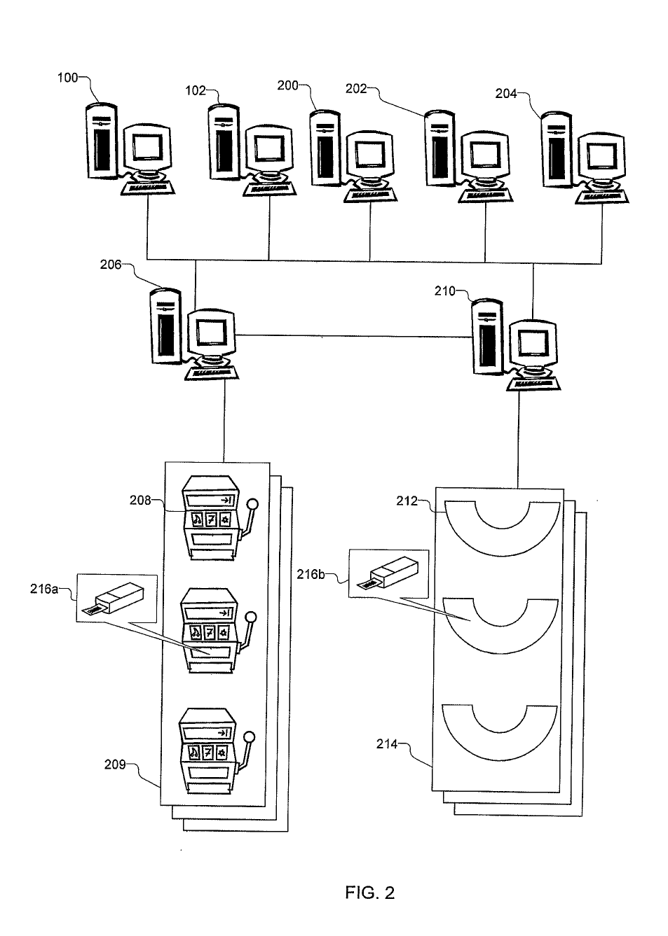

The PCS 100 may be coupled to other systems 104 to send and receive data and signaling. Other systems 104 may include one or more other systems in use at a gaming establishment such as a player tracking system, slot host system, table host system, and point-of-sale system as later described in FIG. 2 as well as a property or lodging management system, among others. Additionally, other systems 104 may include any communication and/or messaging system such as telephony, radio, and/or pagers in use at a gaming establishment. For example, the PCS 100 may receive from a cash-out voucher system data which may identify the date and number of promotional coupons issued at a game for an anonymous patron.

In operation of one embodiment, the visual detection system 102 may use one or more cameras, each to acquire an image or photograph of a patron when they enter a gaming establishment or while anywhere within a gaming establishment. The image or photograph may then be compared to a database of the visual detection system 102. The comparison may search for a match to the image or photograph. For example, the system may search for a match to an existing image of a well known patron of the gaming establishment. Once a match is found, the visual detection system 102 may signal the PCS 100 as well as other systems 104. Further, data from the visual detection system 102 may be shared with or transferred to the PCS 100 and/or other systems 104.

In another embodiment, the visual detection system 102 may signal the PCS 100 as well as other systems 104 without determining or searching for a match in the visual detection system 102.

FIG. 2 is an illustration of the PCS 100 coupled to other systems in a gaming establishment to perform promotional couponing in accordance with an exemplary embodiment of the present invention.

As illustrated, the PCS 100 may be coupled to a visual detection system 102, player tracking system (PTS) 200, point-of-sale system (POS) 202, other systems, slot host system, and table host system, among others. Any component or combination of components may be optional. Each system may be coupled to the each other as well as to others not illustrated.

The PCS 100 may send and/or receive data and signaling to and PTS 200 regarding the game play activity of a participating patron which the PTS 200 may administer and monitor.

The PCS 100 may send and/or receive data and signaling to and from the POS 202 regarding the purchasing and/or spending activity of patrons which the POS 202 may administer and monitor.

Other systems 204 may include other systems which may be in use at a gaming establishment such as a property or lodging management system, accounting system, and/or cash-out voucher system, among others. The PCS 100 may send and/or receive data and signaling from other systems regarding the type of information used by other systems.

The PCS 100 may send and/or receive data and signaling from one or more slot host systems, such as slot host system 206, regarding game play activity and/or cash-out activity which the slot host system 206 may administer and monitor. The slot host system 206 may be used by a gaming establishment to monitor one or more coupled games such as slot machines 208, game machines or other games. The slot host system 206 may include a cash-out voucher system. Games may be coupled to the slot host system 206 as a group, such as group 209, for instance a row of games on a gaming floor may belong to one group, a second row may belong to another group, etc. Additionally, one or more groups may belong to one segment of a gaming establishment floor. This may to allow the slot host system 206 to send and receive data and signaling to one or more groups, one or more games within a group or one or more segments of a gaming establishment floor.

The PCS 100 may send and/or receive data and signaling from a table host system 210 regarding game play activity and/or cash-out activity which the table host system 210 may administer and monitor. The table host system 210 may be used by a gaming establishment to monitor one or more coupled games such as game tables 212 or other games. The table host system 210 may include a cash-out voucher system. Games may be coupled to the table host system 210 as a group, such as group 214, for instance a row of games on a gaming floor may belong to one group, a second row may belong to another group, etc. Additionally, one or more groups may belong to one segment of a gaming establishment floor. This may to allow the table host system 210 to send and receive data and signaling to one or more groups, one or more games within a group or one or more segments of a gaming establishment floor.

Each game such as a slot machine, game table, and other games may include a printer among other components, such as printers 216a and 216b. The printers 216a and 216b may be used to generate cash-out vouchers based on signaling received from the slot host system 206 or table host system 210. Additionally, the printers 216a and 216b may be used to generate promotional coupons and/or other items of interest to patrons based on signaling received from the PCS 100.

Although not illustrated, additional systems such as the POS 202 also may include one or more printers among other components. The printer may be used to generate promotional coupons and/or other items of interest to patrons based on signaling received from the PCS 100.

Each system may be coupled to send and receive data and signaling to and from any or all of the others. For example, the table host system 210 may receive signaling from the PTS 200. In another example, the slot host system 206 may send data to the PTS 200.

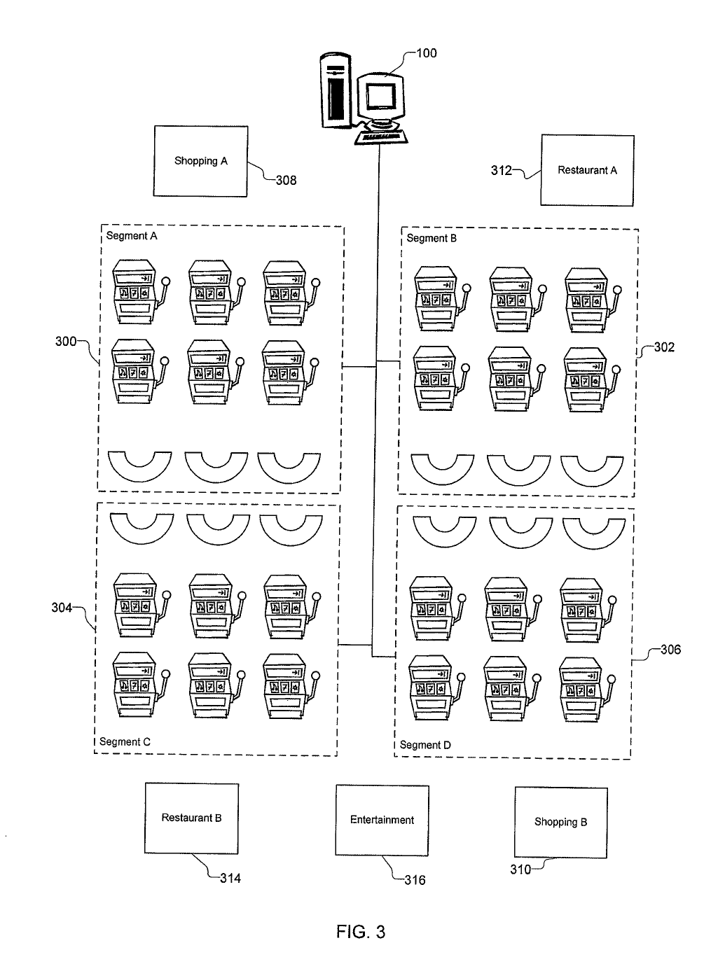

FIG. 3 is an illustration of a segmented gaming establishment floor in accordance with an exemplary embodiment of the present invention. FIG. 3 may include any or all previously described in FIG. 1 and FIG. 2. Any component or combination of components may be optional.

As illustrated, a gaming establishment floor may include a plurality of segments; for example: Segment A 300, Segment B 302, Segment C 304, and Segment D 306. Each segment may include one or more games and/or groups as previously described in FIG. 2.

The floor also may include one or more venues; for example: Shopping A 308, Shopping B 310, Restaurant A 312, Restaurant B 314, and Entertainment 316.

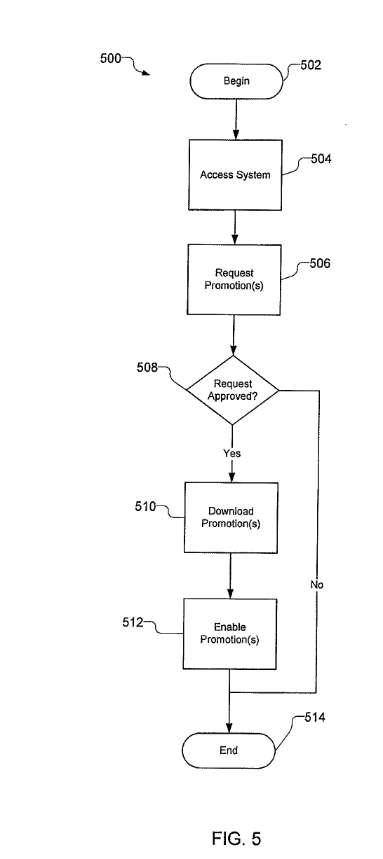

In one embodiment, the PCS 100 may selectively download data and/or enable promotional activity in one or more segments of a gaming establishment floor. This may be accomplished under the direction of a system administrator or administrative control. In this embodiment, the architecture of the PCS 100 may run in a sub-section mode as opposed to a floor-wide mode. The PCS 100 may route promotional activity to one or more segments instead of the entire floor if so desired. Additional information is later described in FIG. 5.

In another embodiment, the PCS 100 may enable promotional activity aimed at steering patron traffic to a particular service or location of the gaming establishment; for example: Shopping A 308, Shopping B 310, Restaurant A 312, Restaurant B 314, and/or Entertainment 316. In this embodiment, authorized personnel such as a bar manager, show manager, food court manager, etc. may log in to the PCS 100 and request the system to enable promotional coupon activities to bring patrons to the manager's venue. The request may be made for floor-wide or segmented floor, such as only to Segment A 300.

The request may have limitations and rules as defined by the PCS 100 and imposed by the system administrator. The rules imposed may include any or all the following, among others:

a) one or more promotions only is available to one or certain floor segments

b) only one promotion per floor segment

c) patron must be identified in the PTS 200

d) patron must be identified by the visual detection system 102

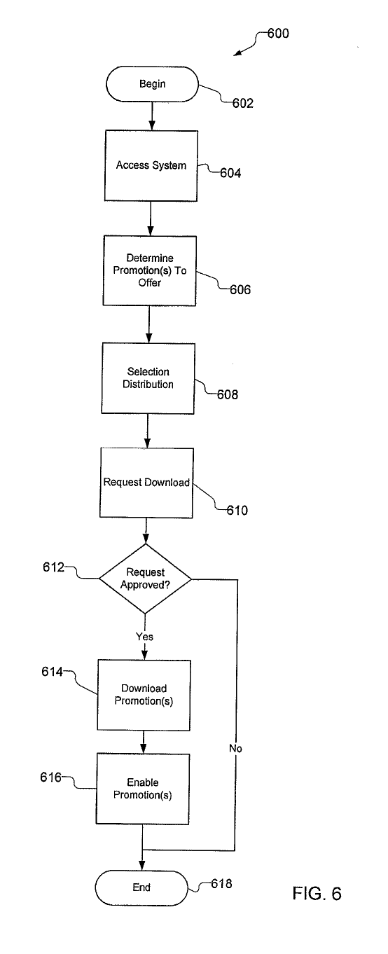

Additionally, the request may be tracked under its own separate accounting process such as by manager, location, and/or effectiveness based on promotional coupon redemption. Additional information is later described in FIG. 6.

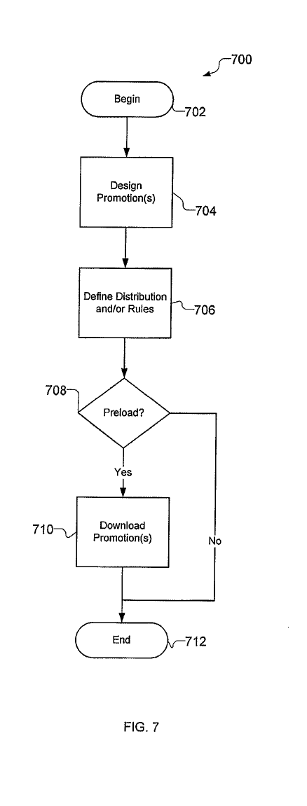

In another embodiment, the PCS 100 may preload promotional couponing to one or more segments of a gaming establishment, the enabling of the promotional activity pending one or more authorizations and/or approvals as later described in FIG. 7.

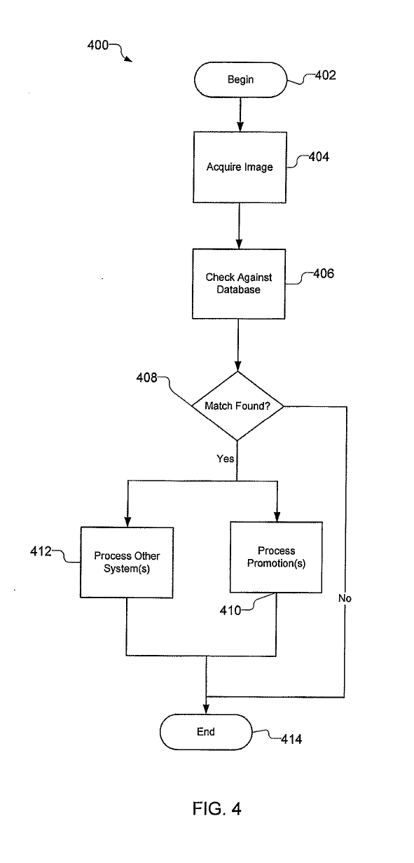

FIG. 4 is a flow chart of a patron recognition process 400 in accordance with an exemplary embodiment of the present invention.

As illustrated, the process 400 begins (402) with acquiring (404) an image where the visual detection system (102 of FIG. 1 or FIG. 2) may use one or more cameras, each to acquire an image or photograph of a patron when the patron enters a gaming establishment or while anywhere within a gaming establishment. The image or photograph then may be compared (406) to a database of the visual detection system 102. The comparison may search for a match to the image or photograph. For example, the system may search for a match to an existing image of a well known patron of the gaming establishment. If a match (408) is found, the visual detection system 102 may signal the PCS 100 to process promotions (410) and signal (412) other system(s) to process other type of information or data appropriate for the system(s). Further, data from the visual detection system 102 may be shared with or transferred to the PCS 100 and/or other system(s). If no match is found, the process may end (414).

FIG. 5 is a flow chart of a promotions request and download process 500 for a segmented gaming establishment floor in accordance with an exemplary embodiment of the present invention.

As previously described, the PCS 100 (of FIGS. 1, 2 and 3) may selectively download data and/or enable promotional activity in one or more segments of a gaming establishment floor.

The process may begin (502) with access system where a manager or other authorized person accesses (504) the PCS 100 to request (506) promotion(s). If the request is approved (508), for instance by a system administrator and/or based on imposed rules, the PCS 100 may download 510 the promotion(s) to one or more segments of a gaming establishment floor after which a manager, for example, may selectively enable (512) one or more promotions. If the request is not approved, the process may end (514).

FIG. 6 is a flow chart of a promotions request and download process 600 for steering patron traffic for a segmented gaming establishment floor in accordance with an exemplary embodiment of the present invention. As previously described, the PCS 100 (of FIGS. 1, 2 and 3) may enable promotional activity aimed at steering patron traffic to a particular service or location of the gaming establishment.

The process 600 may begin (602) with access system where a manager or other authorized person accessing (604) the PCS 100. Thereafter, the PCS 100 may be used to determine (606) promotion(s) to offer where the determination may be made by a system administrator and/or the requesting person, such as the manager.

The distribution of the selected promotion(s) then may be determined (608). This may include one or more segments of a gaming establishment floor. Thereafter, a request (610) for download may be made. If the request is approved 612, for instance by a system administrator and/or based on imposed rules, the PCS 100 may download (614) the promotion(s) to one or more segments of a gaming establishment floor after which a manager, for example, may selectively enable (616) one or more promotions. If the request is not approved, the process may end (618).

FIG. 7 is a flow chart of a promotion create and preload process 700 in accordance with an exemplary embodiment of the present invention. This process 700 defines how the PCS 100 (of FIGS. 1, 2 and 3) may preload promotional couponing to one or more segments of a gaming establishment, the enabling of the promotional activity pending one or more authorizations and/or approvals.

The process may begin (702) with design (704) of promotion(s) where information for each promotion may be defined and designed. This information may include one or more promotional campaigns, one or more promotional coupons, and/or one or more triggers, among other types of information.

Once the design is complete, the process continues with definition (706) of distribution and/or rules where one or more segments or the entire gaming establishment floor may be selected for distribution of one or more promotions. Additionally, rules may be defined which may include or limit the distribution of one or more promotions. For example, a rule may be set to only allow a particular promotion to be distributed in one segment of a gaming establishment floor and not another. In another example, a rule may be set to only allow a particular promotion to be distributed to patrons who are identified in a PTS 200.

One or more promotions may be preloaded (708) to one or more segments or the entire gaming establishment floor. This may allow promotions to be downloaded (710) in real-time without a request being made such as the request processes previously described in FIG. 5 and FIG. 6.

If a determination is made to preload one or more promotions, the PCS 100 may download the promotion(s) to one or more segments of a gaming establishment floor. If not, the process may end (712).

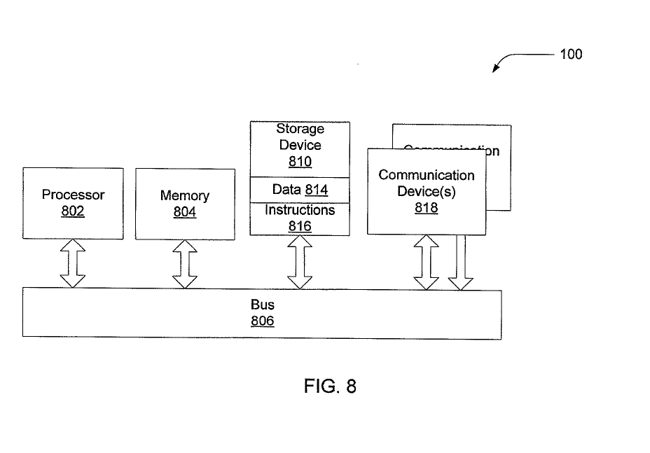

FIG. 8 is a block diagram of a PCS 100 in accordance with an exemplary embodiment of the present invention. A PCS 100 includes a processor 802, operatively coupled via a bus 806 to a memory 804. The processor is further operatively coupled via the bus to a storage device 810. Program instructions 816 and data 814 for implementing previously described PCS 100 processes are stored in the storage device until the processor retrieves the program instructions and stores them in the memory. The processor then executes the program instructions stored in the memory and uses the data to implement the features of the PCS 100 as previously described.

The processor is further coupled via the bus to one or more communication devices or ports 818. The PCS 100 uses the communication devices to transmit and receive control signals from other devices or systems as previously described.

The foregoing description of the components of PCS 100 is provided by way of example and not of limitation, it being understood that PCS 100 could be implemented in a variety of ways without deviating from the spirit of the invention. For example, the processor 802 could be constructed from hardware such as hardwired circuits within a controller. Alternatively, PCS 100 could also be constructed from a combination of hardware and software components.

Although the invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

What is claimed is:

1. A method of operating a promotional coupon system (PCS) for use with a plurality of games in a gaming establishment, the method comprising:
acquiring by the PCS a first image of a patron of the gaming establishment without associating the first image with personal information of the patron, thereby maintaining the patron's anonymity;
acquiring by the PCS a second image of the patron; and
issuing a promotional coupon by the PCS to the patron when the second image is matched to the first image.

2. The method of claim 1, wherein the second image is acquired as the patron plays a game of the plurality of games in the gaming establishment.

3. The method of claim 1, wherein the second image is acquired when the patron enters the gaming establishment.

4. The method of claim 3, wherein the PCS notifies a staff member of the gaming establishment when the patron enters the establishment.

5. The method of claim 1, wherein issuing a promotional coupon to the patron further includes generating the promotional coupon based in which segment of a gaming establishment floor the patron is located.

6. The method of claim 1, wherein issuing a promotional coupon to the patron further includes generating the promotional coupon to direct the patron to a particular location or service in the gaming establishment.

7. The method of claim 1, wherein the image is acquired by the PCS from a visual detection system.

8. The method of claim 1, further comprising tracking of the patron using a unique identifier not associated with any personal information of the patron.

9. The method of claim 1, further comprising selectively downloading promotional activity data to another system associated with a segment of the gaming establishment.

10. The method of claim 1, further comprising selectively enabling promotional activity another system associated with a segment of the gaming establishment.

11. A promotional coupon system (PCS) for use with a plurality of games in a gaming establishment, the PCS comprising a processor configured to: acquire by the PCS a first image of a patron of the gaming establishment without associating the first image with personal information of the patron thereby maintaining the patron's anonymity; acquire by the PCS a second image of the patron; and issue a promotional coupon by the PCS to the patron when the second image is matched to the first image.

12. The PCS of claim 11, wherein the second image is acquired as the patron plays a game of the plurality of games in the gaming establishment.

13. The PCS of claim 11, wherein the second image is acquired when the patron enters the gaming establishment.

14. The PCS of claim 13, wherein the processor is further configured to notify by the PCS a staff member of the gaming establishment when the patron enters the establishment.

15. The PCS of claim 11, wherein issuing a promotional coupon to the patron further includes generating the promotional coupon based in which segment of a gaming establishment floor the patron is located.

16. The PCS of claim 11, wherein issuing a promotional coupon to the patron further includes generating the promotional coupon to direct the patron to a particular location or service in the gaming establishment.

17. The PCS of claim 11, wherein the image is acquired by the PCS from a visual detection system.

18. The PCS of claim 11, wherein the processor is further configured to track the patron using a unique identifier not associated with any personal information of the patron.

19. The PCS of claim 11, wherein the processor is further configured to selectively download promotional activity data to another system associated with a segment of the gaming establishment.

20. The PCS of claim 11, wherein the processor is further configured to selectively enable promotional activity another system associated with a segment of the gaming establishment.
